(19) United States
(12) Patent Application Publication
(10) Pub. No.: US 2009/0116239 A1
(43) Pub. Date: May 7, 2009

(54) STRUCTURE OF A FASTENER WITH ILLUMINATORS

(75) Inventors: Shi-Shan WU, Kaohsiung (TW); Hung-Ling CHANG, Kaohsiung (TW); Jing-Ren HU, Kaohsiung (TW); Yu-Ren LO, Kaohsiung (TW)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW ELECTRONIC BUSINESS ASIA CO. LTD., Kaohsiung (TW)

(21) Appl. No.: 12/258,528

(22) Filed: Oct. 27, 2008

(30) Foreign Application Priority Data
Nov. 7, 2007 (TW) 96218757

(51) Int. Cl. F21V 33/00

(52) U.S. Cl. 362/253

(57) ABSTRACT

A fastener includes a main body, a light guide, and a threaded securing member. The light guide is fit over the main body. The main body with the light guide thereon is fit into a mounting hole of a mounting plate and the threaded securing member engages a threaded section of the main body, whereby a top retention portion of the main body and the threaded securing member together establish abutting engagement that securely fixes the main body to the mounting hole. A light source unit is arranged in the threaded securing member and connected to a power source. Illuminators are mounted on the light source unit may give off light that is guided by the light guide to emit through a light emission portion of the light guide. Thus, the light emission portion of the main body may serve as a lighting ring for warning or indication purposes.

### (a) TECHNICAL FIELD OF THE INVENTION

The present invention generally relates to a structure of a fastener with illuminators, and particularly to a structure that simplifies conversion of a fastener that originally contains no light source into one that contains a light source and that realizes a substantial reduction of costs.

### (b) DESCRIPTION OF THE PRIOR ART

A conventional fastening device, such as a threadingly fixed switch and a threaded fastening element for jointing plates, provides a fastening function. Taking the threadingly fixed switch as an example, the threadingly fixed switch can be a warning switch that contains a light source or one that contains no light source. The no-light-source switch 1, as shown in FIG. 1, comprises at least a main body 11 and a threaded securing member 12. Inside the main body 11, a switch assembly 13 is received and retained. A front portion of the main body 11 is diverged to form a top retention portion 111 from a rear side of which a threaded section 112 extends. The threaded section 112 functions to form a threading engagement with the threaded securing member 12. As shown in FIG. 2, with the threaded section 112 of the main body 11 fit into a mounting hole 21 defined in a mounting plate 2 and further with the threaded securing member 12 engaging the threaded section 112 of the main body 11, abutting engagement is established by the top retention portion 111 of the main body 11 and the threaded securing member 12 so as to securely fix the switch 1 on the mounting plate 2.

However, in certain applications where the no-light-source switch 1 is required to additionally include a light source for warning or indication purposes, the no-light-source switch 1 has to be completely removed and replaced with a switch that contains a light source. This inevitably increases the costs of switch replacement. Thus, it is a challenge of the industry to realize the desired warning or indication light source through a simple structural conversion effected on the switch 1 that originally contains no light source.

### SUMMARY OF THE INVENTION

In order to overcome the problems associated with high costs and complication of the conventional way for conversion of a fastener that contains no light source into one that contains a light source, an objective of the present invention aims to provide a structure of a fastener with illuminators, wherein by modifying a threaded securing member of a light source unit and adding a light guide, a fastener that originally contains no light source can be converted into one that contains a light source in a simplified manner and the costs for such a conversion is made low.

To realize such an objective, the present invention adopts the following technical feature. A structure of a fastener with illuminators comprises a main body, a light guide, and a threaded securing member. The light guide is fit over the main body. Then, the main body with the light guide fit thereon is fit into a mounting hole formed in a mounting plate and the threaded securing member threadingly engages a threaded section of the main body, whereby a top retention portion of the main body and the threaded securing member together establish abutting engagement that securely fixes the main body to the mounting hole of the mounting plate. With a light source unit that is arranged in the threaded securing member being connected to a power source, illuminators mounted on the light source unit are lit and give off light and the light from the light source unit is guided by the light guide so that a light emission portion of the light guide illuminates. Thus, a top portion of the main body may serve as a lighting or illuminating ring for warning or indication purposes.

Another technical feature of the present invention is that a switch assembly is further arranged inside the main body whereby a simple conversion of a switch that originally contains no light source into one that contains a light source can be easily realized. Thus, the present invention is further applicable to the conversion of switches that original contain no light source.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a conventional no-light-source switch.

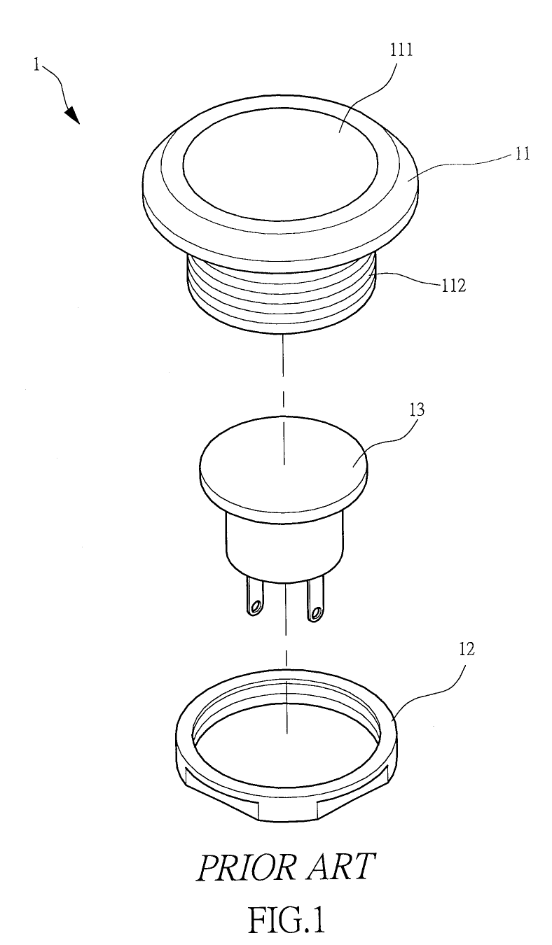

FIG. 2 is a cross-sectional view schematically illustrating an application of the conventional no-light-source switch.

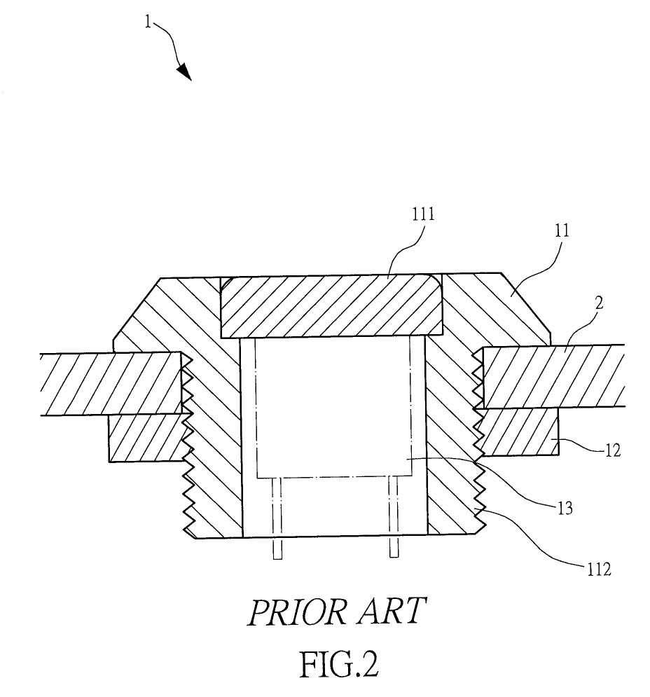

FIG. 3 is an exploded view of a structure of a fastener with illuminating in accordance with the present invention.

FIG. 4 is a cross-sectional view of the fastener of FIG. 3 in an assembled form.

FIG. 5 is an exploded view of another embodiment of the present invention.

FIG. 6 is a cross-sectional view of the embodiment of FIG. 5 in an assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

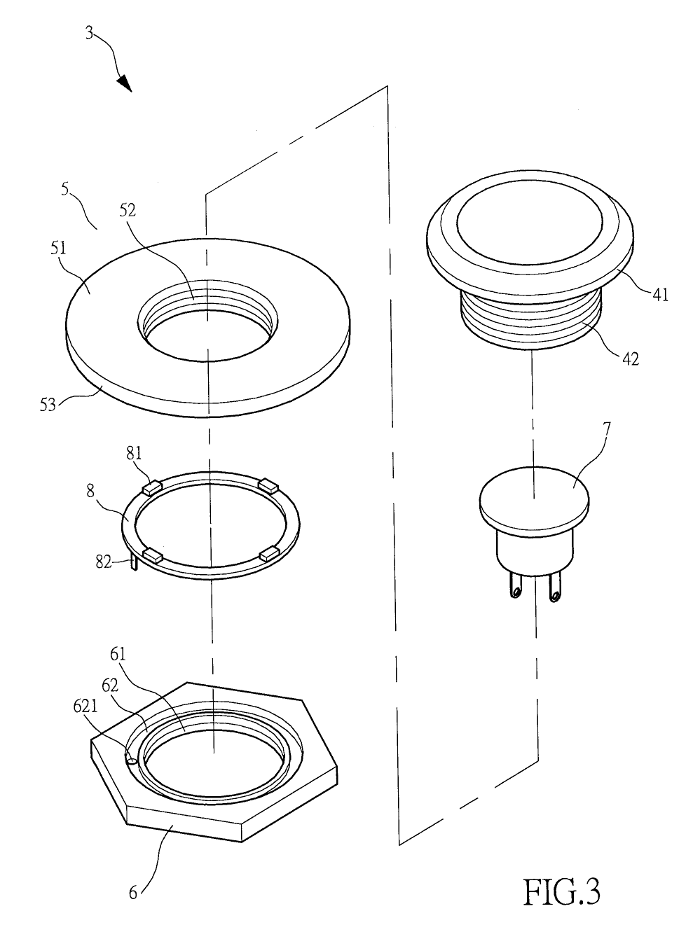

With initial reference to FIG. 3, a fastener in accordance with the present invention, generally designated at 3, comprises a main body 4, a light guide 5, and a threaded securing member 6.

The main body 4 has a top end forming a top retention portion 41. The main body 4 has a rear portion extending therefrom and forming a threaded section 42. The main body 4 allows arrangement of a switch assembly 7 therein.

The light guide 5 has a top portion forming a platen-like light emission portion 51. The light emission portion 51 forms a bore 52 in a central portion thereof. A lower edge of the bore 52 extends downward to form a light guide portion 53.

The threaded securing member 6 forms in a central portion thereof a through hole 61. A circumferential groove 62 is formed adjacent and around the through hole 61. The groove 62 receives a light source unit 8 therein. The light source unit 8 comprises a plurality of illuminators 81, which can be embodied as light-emitting diodes (LEDs). A lead passage 621 is defined through a bottom of the groove 62. The lead passage 621 allows the extension of power terminals 82 of the light source unit 8.

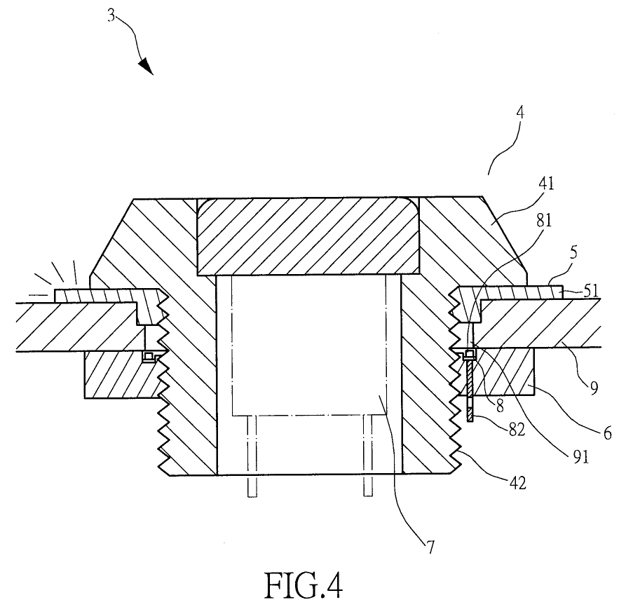

In the practice of the present invention, as shown in FIG. 4, the light guide 5 is first fit over the main body 4 that receives the switch assembly 7 therein. Then, the main body 4, together with the light guide 5, is fit through a mounting hole 91 defined in a mounting board 9. Thereafter, the threaded securing member 6 threadingly engages the threaded section 42 of the main body 4, whereby with the tight retention engagement realized through the top retention portion 41 of the main body 4 and the threaded securing member 6, the main body 4 is securely fixed to the mounting hole 91 of the mounting board 9. As such, with the light source unit 8 that is arranged in the threaded securing member 6 being connected to a power source, the illuminators 81 of the light source unit 8 are lit and give off light. The light from the light source unit 8 is guided by the light guide 5 so that the light emission portion 51 of the light guide 5 illuminates. Thus, the top portion of the main body 4 may serve as a lighting or illuminating ring for warning or indication purposes.

The effectiveness of the present invention is that when a switch 1 that does not contain a light source needs a warning or indication lighting ring due to the requirement of applications, it only needs to replace a conventional threaded securing member 12 of the switch 1 with the threaded securing member 6 of that present invention that contains the light source unit 8 and to further add the light guide 5 in accordance with the present invention so that the switch 1 that originally contains no light source is added with a lighting ring for warning or indication purposes. With such an arrangement, the present invention realizes simple conversion of a no-light-source switch 1 into one that contains a light source.

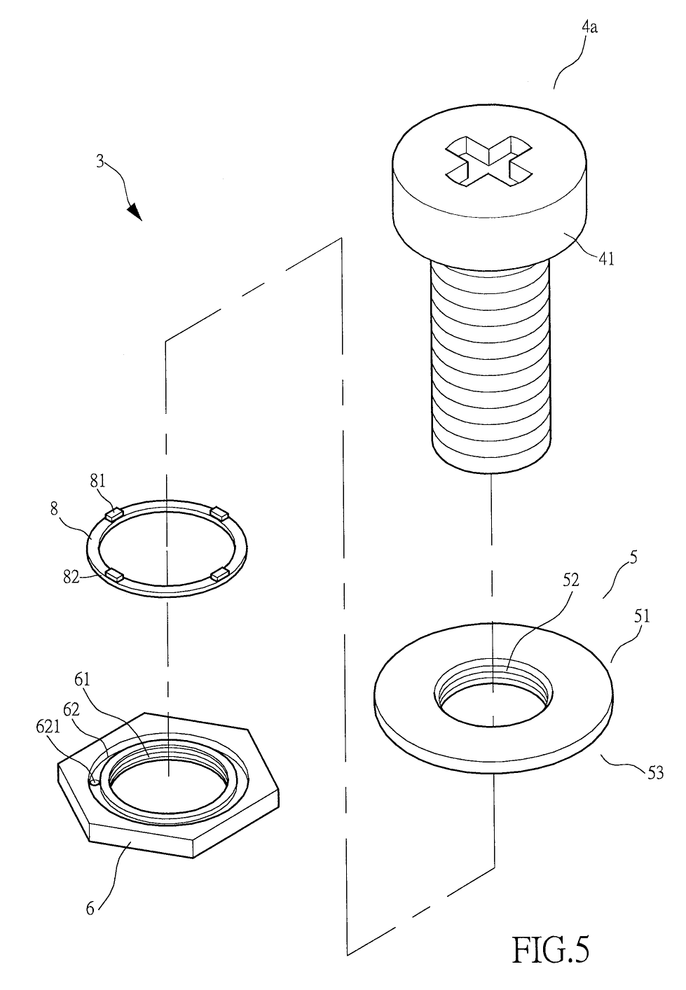

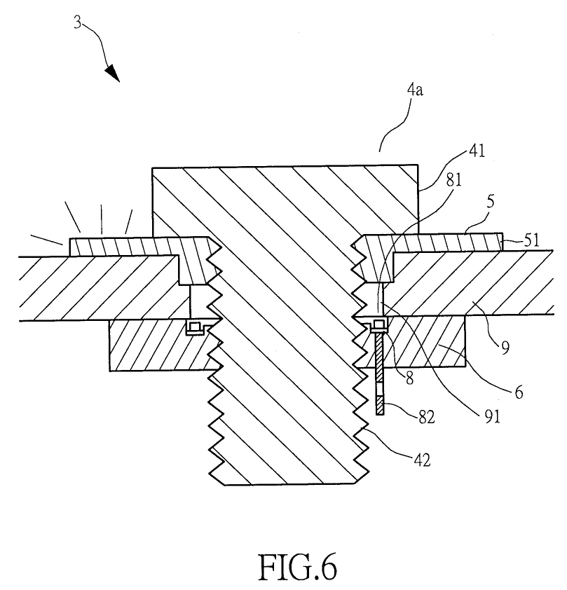

When the fastener 3 of the present invention is a simple fastening device that contains no switch assembly 7, as shown in FIGS. 5 and 6, the light guide 5 is first fit onto the main body 4a and the main body 4a, together with the light guide 5, is then into the mounting hole 91 of the mounting board 9. The threaded securing member 6 is set in threading engagement with the threaded section 42 of the main body 4a, whereby with abutting engagement realized through the top retention portion 41 of the main body 4a and the threaded securing member 6, the main body 4a is now securely fixed to the mounting hole 91 of the mounting board 9. As such, with the light source unit 8 that is arranged in the threaded securing member 6 being connected to a power source, the illuminators 81 of the light source unit 8 are lit and give off light. The light from the light source unit 8 is guided by the light guide 5 so that the light emission portion 51 of the light guide 5 illuminates. Thus, the top portion of the main body 4 may serve as a lighting or illuminating ring for warning or indication purposes. With such a structural arrangement, similarly, for a conventional fastener that does not contain a light source needs a warning or indication lighting ring, it only needs to replace a conventional threaded securing member 12 of the conventional fastener with the threaded securing member 6 of that present invention that contains the light source unit 8 and to further add the light guide 5 in accordance with the present invention so that the conventional fastener can be provided with a lighting ring for warning or indication purposes. With such an arrangement, simple conversion of a no-light-source fastener into one that contains a light source can be realized.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fastener comprising at least a main body and a threaded securing member, characterized in that a light source unit is arranged in the threaded securing member and a light guide is fit over the main body, the light guide being arranged above the threaded securing member and positioned in a front portion of the main body, whereby light generated from the light source unit is guided toward a front side of the main body through the light guide to form a lighting ring at the front portion of the main body.

2. The fastener according to claim 1, wherein the main body contains a switch assembly therein.

3. The fastener according to claim 1, wherein the main body comprises at least a top retention portion and a threaded section.

4. The fastener according to claim 1, wherein the threaded securing member forms a groove in which the light source unit is received.

5. The fastener according to claim 4, wherein a lead passage is defined through a bottom of the groove of the threaded securing member.

6. The fastener according to claim 1, wherein the light source unit comprises a light guide portion and a light emission portion.

7. The fastener according to claim 1, wherein the light source unit comprises a plurality of illuminators.

8. The fastener according to claim 7, wherein the illuminators comprise light-emitting diodes.
